(19) United States
(12) Patent Application Publication
(10) Pub. No.: US 2007/0087598 A1
(43) Pub. Date: Apr. 19, 2007

(54) Interconnect and method for joining receptacles

(76) Inventor: Jean-Pascal Zambaux, Allonzier la Caille (FR)

Correspondence Address: INTELLECTUAL PROPERTY / TECHNOLOGY LAW, PO BOX 14329, RESEARCH TRIANGLE PARK, NC, 27709, US

(21) Appl. No.: 11/581,652

(22) Filed: Oct. 16, 2006

Related U.S. Application Data
(60) Provisional application No. 60/727,524, filed on Oct. 17, 2005.

(51) Int. Cl. H01R 13/44

(52) U.S. Cl. 439/145

(57) ABSTRACT

A connector is provided for forming a substance transfer pathway between two or more volumes without exposing the interior contents of the volumes to an exterior environment. A removable cover is provided over a flap-defining membrane or boundary element, wit h the flap including an adhesive. Two receptacles and/or conduits may be connected to one another with corresponding connectors by removing the covers, registering the flaps, joining the receptacles and/or conduits, and then freeing the flaps from the surrounding membranes.

### STATEMENT OF RELATED APPLICATION(S)

This application claims benefit of U.S. Provisional Patent Application No. 60/727,524, filed on Oct. 17, 2005.

### FIELD OF THE INVENTION

The present invention relates to interconnects, systems containing such interconnects, and methods of using such interconnects for connecting or joining various receptacles, including receptacles used for the processing (e.g., mixing and/or reacting) of various substances in laboratory and industrial settings.

### DESCRIPTION OF THE RELATED ART

Mixing and/or reacting of components, such as different types of solids, liquids and/or gases, has numerous applications in different industries. For example, in the pharmaceutical industry, different types of drug precursor materials and/or therapeutic agents are mixed and/or reacted. In the medical field, components such as body fluids and/or drugs are mixed and/or reacted. In the semiconductor field, wet solutions are combined with abrasives to make slurries. The food industry also incorporates mixing operations into a number of applications, including the mixing of water with dried food to accomplish rehydration.

In these and other industries, however, the components to be mixed or reacted may be hazardous, dangerous, infectious and/or require high levels of purity. For example, in the pharmaceutical and/or medical industries, components subject to mixing or reacting operations may be toxic. In the medical field, fluids to be processed may contain live viruses (e.g., HIV) or other pathogens, justifying the need for individuals to avoid contact with such fluids. Furthermore, in the semiconductor industry, handling of chemicals is avoided to reduce the potential for forming particulates and introducing impurities. For these reasons, it is desirable to accomplish mixing or reacting steps in sealed substance processing assemblies fabricated with non-reactive materials.

Conventional systems for mixing and/or reacting substances utilize reusable tanks fabricated from materials such as glass or stainless steel, and associated agitation means. Prior to use, these tanks typically must be washed and sterilized. An autoclave may be used for washing and sterilizing small volume tanks, while a water steam-based operation may be employed for washing and sterilizing larger volume tanks. When preparing batches of post-etch residue removers for semiconductor applications, introduction of contaminants must be excluded at all levels of processing to decrease particulate formation, which leads to failure of finished semiconductor devices. These washing, sterilizing, and processing operations are often time-consuming and expensive, and require highly qualified individuals for their performance.

Single-use (disposable) fluid processing receptacles, such as disclosed in commonly assigned U.S. Patent Application Publication No. 20040233779 entitled “Flexible mixing bag for mixing solids, liquids and gases”, have recently been developed by ATMI, Inc. (Danbury, Conn.) to address at least some of the challenges described herein. Even if such receptacles are used, however, certain difficulties persist in connecting multiple receptacles together to permit fluid communication between such receptacles.

In consequence, the art continues to seek improvements for fluid processing receptacles and interconnects therefor.

It would be desirable to avoid introducing contaminants into such receptacles when performing an interconnection step. Since even brief exposure to an ambient environment can enable the introduction of microorganisms and particulate matter into a container, it would be desirable to permit receptacles to be interconnected without opening a pathway to the ambient environment during an interconnection step. It would also be desirable for a connector to be sterilizable together with its associated processing receptacle. It would also be desirable to provide backup means to ensure the sterility of surfaces in a fluidic interconnect subject to contact with the contents of one of more processing receptacles. Moreover, it would be desirable to reduce the need for packaging required to maintain a receptacle interconnect sterile during transport and handling of the receptacle. It would also be desirable for a receptacle interconnect to be sufficiently simple and inexpensive to make it cost-effective to be disposed after a single use if desired.

### SUMMARY OF THE INVENTION

The present invention relates to improvement interconnects, systems comprising such interconnects and methods of making and using the same.

Applicant has recognized that it would be desirable to avoid introducing contaminants into such receptacles when performing an interconnection step. Since even brief exposure to an ambient environment can enable the introduction of microorganisms and particulate matter into a receptacle, it would be desirable to permit receptacles to be interconnected without opening a pathway to the ambient environment during an interconnection step. Applicant also recognized that it would also be desirable for a connector to be sterilizable together with its associated processing receptacle. It would also be desirable to provide backup means to ensure the sterility of surfaces in a fluidic interconnect subject to contact with the contents of one of more processing receptacles. Moreover, it would be desirable to reduce the need for packaging required to maintain a receptacle interconnect sterile during transport and handling of the receptacle. It would also be desirable for a receptacle interconnect to be sufficiently simple and inexpensive to make it cost-effective to be disposed after a single use if desired. The present invention relates to interconnects providing one or more of the above-identified desirable features.

One embodiment of the invention relates to a receptacle connector comprising:
(a) a protruding flange having an aperture-defining wall;
(b) a first membrane spanning across the aperture joined to the flange, the first membrane having an inner surface, an outer surface, and defining a flap portion, and
(c) a second membrane removably adhered to the outer surface of the first membrane, with the second membrane intended to be removed prior to the joining of one receptacle connector to another of like type.

Another embodiment relates to a connector for a receptacle and/or a conduit, the connector comprising:
(a) a flap defined in a boundary element bounding at least a portion of an interior volume defined by a first receptacle or conduit, wherein a portion of the flap is adapted to be separated from the boundary element; and
(b) a cover removably joined to the boundary element and spanning across the flap

Another embodiment relates to a receptacle comprising one or more of the above-described receptacle connectors and methods of using the same.

Another embodiment relates to a mixing system comprising one or more of the above-described receptacles and/or one or more of the above-described receptacle connectors, and methods of using the same.

Yet another embodiment relates to a method for forming a substance transfer pathway between two or more volumes having outlets without exposing the interior contents of said two or more volumes to the environment exterior to said volumes, wherein each volume is bounded by an interior surface including an interior surface of an outlet cover, said outlet cover having an exterior surface, wherein said method comprises the steps of registering the exterior surface of the outlet cover of a first volume with the exterior surface of the outlet cover of a second volume, sealing the exterior surface of the outlet cover of the first volume to the exterior surface of the outlet cover of the second volume, and opening a pathway through the outlet of the first volume and the outlet of the second volume without exposing the interior contents of the first volume and the second volume to any of the exterior surface of the first outlet cover and the second outlet cover. According to one preferable embodiment, the two or more volumes are two or more receptacles. According to another embodiment, the two or more volumes include a receptacle and a conduit (e.g., a tube, hose, pipe, duct, or the like). Preferably, one or more of the exterior surfaces of said outlet covers comprises an adhesive to seal said exterior surfaces of said outlet covers upon contact.

Yet another embodiment relates to a method for facilitating substance transfer between two receptacles comprising:
(a) providing a first receptacle having a first protruding flange including a first wall defining a first aperture and having a first inner membrane joined to the first flange, with the first inner membrane spanning across the first aperture and defining a first flap portion substantially restrained by the first inner membrane;
(b) providing a second receptacle having a second protruding flange including a second wall defining a second aperture and having a second inner membrane joined to the second flange, with the second inner membrane spanning across the second aperture and defining a second flap portion substantially restrained by the second inner membrane;
(c) registering the first flange and the second flange such that the first flap portion is substantially registered with the second flap portion;
(d) joining the first flange and the second flange, preferably including adhering the first outer surface to the second outer surface,
(e) freeing the first flap portion from the first inner membrane and the second flap portion from the second inner membrane to open a pathway between the first receptacle to the second receptacle.

Yet another embodiment relates to a method for facilitating substance transfer between at least one receptacle and a transfer conduit comprising:
(a) providing a first receptacle having a first protruding flange including a first wall defining a first aperture and having a first inner membrane joined to the first flange, with the first inner membrane spanning across the first aperture and defining a first flap portion substantially restrained by the first inner membrane;
(f) providing a transfer conduit comprising at one end a connector having a second protruding flange including a second wall defining a second aperture and having a second inner membrane joined to the second flange, with the second inner membrane spanning across the second aperture and defining a second flap portion substantially restrained by the second inner membrane;
(g) registering the first flange and the second flange such that the first flap portion is substantially registered with the second flap portion;
(h) joining the first flange and the second flange, preferably including adhering the first outer surface to the second outer surface,
(i) freeing the first flap portion from the first inner membrane and the second flap portion from the second inner membrane to open a pathway between the receptacle to the transfer conduit.

Other aspects, features and embodiments of the invention will be more fully apparent from the ensuing disclosure and appended claims.

### BRIEF DESCRIPTION OF THE DRAWINGS

In the drawings, like numbers are intended to refer to like elements or structures. None of the drawings are drawn to scale unless indicated otherwise.

FIG. 1 illustrates a cross-sectional view of a connector flange joined to a portion of a receptacle, with the view taken along section line “A”-“A” shown in FIG. 3.

FIG. 2 illustrates a side view of the connector flange of FIG. 1, the flange including an external alignment mark.

FIG. 3 illustrates a frontal view of the connector flange of FIGS. 1-2.

FIG. 4 is a cross-sectional assembly view of the connector flange of FIGS. 1-3, a first membrane, and a second membrane.

FIG. 5A illustrates a cross-sectional view of the connector flange and receptacle portion of FIG. 1, the connector flange further including two membranes, with an arrow indicating the direction in which the outermost membrane may be removed by a user via a peripherally extended portion or pull tab.

FIG. 5B illustrates a frontal view of the connector flange and outermost membrane of FIG. 5A.

FIG. 6A illustrates the same view as FIG. 5A following removal of the outermost membrane.

FIG. 6B illustrates a frontal view of the connector flange and inner membrane of FIG. 5A.

FIG. 7A illustrates a cross-sectional assembly view of two connector flanges with inner membranes along with portions of two receptacles, including arrows showing the direction in which the flanges and receptacles may be moved to permit them to be joined together.

FIG. 7B illustrates a side view of the connector flanges of FIG. 7A contacting one another, with the external alignment mark of each connector flange registered with the other.

FIG. 7C illustrates a cross-sectional view of the connector flanges of FIGS. 7A-7B joined to one another with an external clamp.

FIG. 8 illustrates a cross-sectional view of the joined connector flanges of FIG. 7C, showing the inner membranes of the flanges adhered together with the joined flap portions freed from the inner membranes, and further providing an arrow showing the direction in which the joined flap portions are forced to accomplish the separation between the joined flap portions and the surrounding joined inner membranes.

FIG. 9 illustrates the same view as FIG. 8, but with the addition of an external tank or support proximate to each receptacle, and with the omission of the directional arrow.

FIG. 10 illustrates a perspective view of an assembly including two flexible receptacles disposed within rigid supports and joined together via clamped connector flanges, the receptacles or supports further including outwardly visible instructions or indicia, with the flexible receptacles within the rigid supports being represented by shadowed lines.

FIG. 11 illustrates a perspective view of an assembly including three flexible receptacles disposed within rigid supports and joined together via a conduit, with the flexible receptacles within the rigid supports being represented by shadowed lines.

FIG. 12A is a cross-sectional assembly view of a flap-defining portion of a boundary element and a cover.

FIG. 12B is a frontal view of the flap-defining portion of the boundary element of FIG. 12A.

FIG. 13A is a cross-sectional view of the boundary element portion and cover of FIG. 12A removably joined together with the cover spanning across the flap.

FIG. 13B is a frontal view of the cover and boundary element portion of FIG. 13A.

FIG. 14 illustrates a perspective view of a processing receptacle for use with a connector flange according to the present invention, the receptacle having a hollow sleeve containing a mixing element and a connecting rod, with features internal to the various external structures represented by shadowed lines.

### DETAILED DESCRIPTION OF THE INVENTION AND PREFERRED EMBODIMENTS THEREOF

The disclosures of the following patents/applications are hereby incorporated by reference as if set forth herein: U.S. Pat. No. 6,749,808 entitled “Sterilizable container with a sterilizable adapter for docking to a port of an isolation system”; U.S. Patent Application Publication No. 2005/0078552 entitled “Flexible mixing bag for mixing solids, liquids and gases;” and U.S. Patent Application Publication No. 2004/0233779 entitled “Flexible mixing bag for mixing solids, liquids and gases;” all of which are commonly assigned to the assignee of the present application.

Various shortcomings associated with processing receptacles and method for interconnecting the same are overcome by embodiments of the present invention. For example, the introduction of contaminants into the interior of receptacles to be connected may be substantially reduced or eliminated by the use of a flap-defining scored membrane covering an aperture-defining flange associated with each receptacle. Each flap portion is preferably substantially restrained by the surrounding membrane until the flange of each receptacle is joined to the other. After the two receptacles are joined, each flap portion is freed from the surrounding membrane to open a pathway between the receptacles to facilitate substance transfer from one receptacle to the other. In this manner, exposure of the interior of receptacle to the ambient environment or to the exterior surfaces of the membranes is dramatically reduced or avoided entirely. Further details of, modifications to, and enhancements to this basic concept are provided herein.

In preferred embodiments, each receptacle comprises a bag or collapsible tank fabricated of substantially non-rigid materials. Such a tank or bag is preferably constructed with a polymeric film such as high-density or low-density polyethylene. If desired, the bag or tank may be structurally supported within a rigid support (e.g., a rigid tank or enclosure) or a substantially open frame with appropriate hooks or other fasteners. One advantage of using nonrigid materials for forming a receptacle is that a receptacle so formed is inexpensive and may be readily disposed, thus facilitating “single use” operation and thereby avoiding the above-mentioned difficulties associated with cleaning and/or sterilizing a multi-use receptacle between batches to be processed.

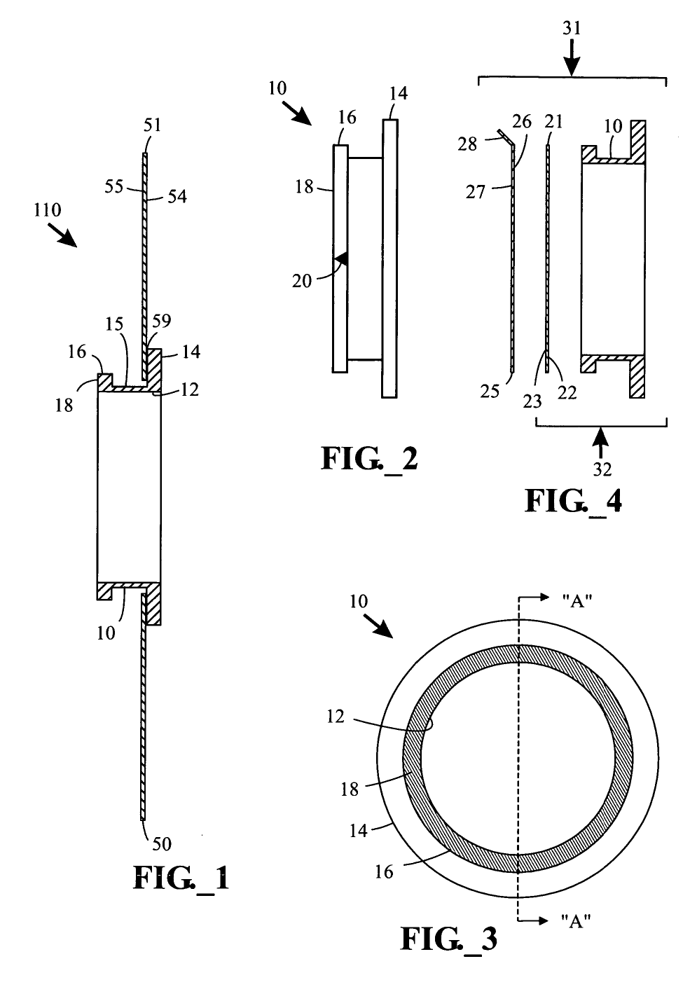

An assembly 110 including a connector flange 10 joined to a receptacle 50 is illustrated in cross-sectional view in FIG. 1 (with the cross-sectional view taken along section line “A”-“A” illustrated in FIG. 3). While only a portion of the wall 51 of the receptacle 50 is shown in FIG. 1, it is to be understood that the receptacle 50 is intended to define a substantially enclosed interior suitable for storing and/or processing one or more substances. The receptacle wall 51 includes an inner surface 54 and an outer surface 55.

A flange 10 having a wall 15 defining an aperture 12 is joined to the receptacle 50. According to another embodiment, connector flange 10 may be integral to receptacle 50 rather than a separate component (not shown). The flange 10 further includes an enlarged or flared outer portion or lip 16 terminating at a face 18, and defines an enlarged inner portion or lip 14 to which the receptacle 50 may be joined. The flange 10 and the receptacle 50 may be joined by any appropriate means, such as mechanical means, ultrasonic welding, solvent welding, thermal bonding, and adhesive bonding. The interface between the inner portion or lip 14 and the inner surface 54 of the receptacle forms a joint 59.

External views of the flange 10 are provided in FIGS. 2-3 without any associated receptacle for clarity. The proximal outer face 18 of the flange 10 is shaded in FIG. 3 to represent that it is raised relative to the flared inner lip 14. The side view of the flange 10 provided in FIG. 2 illustrates an alignment mark 20 permitting the flange 10 of one receptacle to be easily aligned or registered with the flange 10 of another receptacle.

A cross-sectional assembly view of the connector flange 10 of FIGS. 1-3, a first flap-defining membrane 21, and a second membrane 25 is provided in FIG. 4. The first membrane 21 and the second membrane 25 preferably comprise reasonably durable and substantially non-reactive materials, such as any of: polymeric films, metal foils, polymer-coated foils, or equivalent materials. The combination of the flange 10 and the first membrane 21 forms a first assembly 32, while the combination of the flange 10, the first membrane 21, and the second membrane 25 forms a second assembly 31.

While various materials and construction methods may be used to fabricate a connector flange 10 provided herein, preferred embodiments employ polymeric materials and are molded (e.g., injection-molded). Polyethylene materials including low- and high-density polyethylene are particularly preferred materials. Substantially optically transmissive or transparent materials may desirably be used to form connector flanges to permit the contents of a flange 10 to be viewed or inspected. Benefits of utilizing such materials include low fabrication cost, compatibility (e.g., non-reactivity) with a wide variety of substances used in industrial and laboratory settings, and amenability to being sterilized where required for certain applications. Low fabrication cost renders drain connectors as disclosed herein suitable for single- or disposable-use operation, thus eliminating costly cleaning/sterilizing operations and eliminating the possibility of carryover between batches.

Preferably, the materials of fabrication for the receptacle and accompanying connector(s) and membrane(s) and/or the receptacle, connectors and/or membranes are substantially free of particulate matter (at least along interior portions or surfaces thereof) to prevent contamination of substances to be contained, transferred, or otherwise processed therein. The concentration of particulates of 1 micron or greater size on such surfaces is preferably less than about 10 particles per cm2; more preferably less than about 1 particle per cm2; and still more preferably less than about 1 particle per 10 cm2. According to another preferred embodiment, the materials comply with the MIL-STD-1246C standard for product cleanliness levels and contamination control (Institute of Environmental Sciences and Technology.

Preferably, the materials used to make the receptacle and/or connector are also porogen free or substantially porogen free. Examples of such materials are described in U.S. Application Ser. No. 10/658,034. According to preferred embodiments, the presence of porogens in such materials of fabrication is preferably less than about 0.2 weight percent; more preferably less than about 0.05 weight percent; and still more preferably less than about 0.01 weight percent.

The first membrane 21 is preferably permanently joined to the flange 10 (e.g., by ultrasonic welding, solvent welding, adhesive bonding, thermal bonding, or equivalent joining methods), such as by joining the inner surface 22 of the first membrane 21 with the face 18 of the flange 10. Preferably, the second membrane 25 is removably joined to the first membrane 21, such as by adhering the inner surface 26 of the second membrane 25 to the outer surface 23 of the first membrane 21 with a removable adhesive. The second membrane 25 preferably includes at least a portion that extends radially outward past the wall 15 of the associated flange 10 to permit a user to grasp and remove the second membrane 25 from the assembly 31, with the extended (at least a) portion comprising a pull tab 28 adapted to be grasped by the fingers of a user in a particularly preferred embodiment. In a preferred embodiment, the removable adhesive joining the first membrane 21 and the second membrane 25 comprises an anti-microbial substance, such as, for example, triclosan and/or triclocarban. The addition of an anti-microbial substance provides further assurance that live microorganisms will not be introduced into receptacles during a receptacle connection step, thus avoiding contamination problems. Either or both of the first membrane 21 and the second membrane 25 preferably comprises a self-adhesive film.

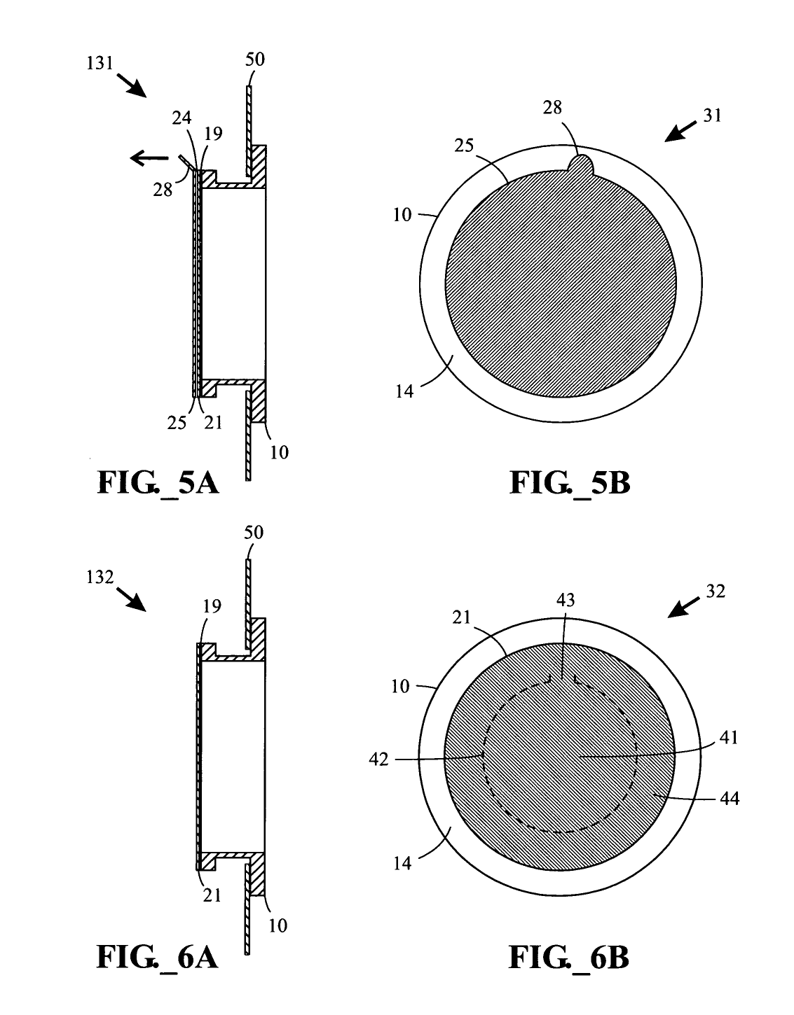

An assembly 131 including the receptacle 50, flange 10, first membrane 21, and second membrane 25is shown in FIG. 5A. The preferably permanent connection between the first membrane 21 and the flange 10 (e.g., along the face 18) is illustrated as a first joint 19, while the preferably non-permanent (e.g., removable adhesive) connection between the first membrane 21 and the second membrane 25 is illustrated as a second joint 24. An arrow illustrated in FIG. SA indicates the direction in which the second membrane 25 may be removed from the first membrane 21 by a user via the peripherally extended portion or pull tab 28.

A frontal view of the assembly 31 of FIG. 4 (substantially identical to the assembly 131 of FIG. 5A except for the omission of the receptacle 50 for clarity) is shown in FIG. 5B, with the second membrane 25 being shaded for emphasis. The second membrane 25 is used to prevent contaminants or debris from contacting the first membrane 21 during transit or handling, with the second membrane 25 preferably being removed only immediately before the receptacle 50 is to be connected to another like receptacle.

Another assembly 132 including the receptacle 50, flange 10, and first membrane 21 (i.e., following removal of the second membrane 25 shown in FIG. 5A) is shown in FIG. 6A. Preferably, removal of the second membrane 25 exposes an adhesive layer along the outer face 23 of the first membrane 21. This assembly 132 is ready to be joined to another assembly in a like state.

A frontal view of the assembly 32 of FIG. 4 (substantially identical to the assembly 132 of FIG. 6A except for the omission of the receptacle 50 for clarity) is shown in FIG. 6B, with the first membrane 21 being shaded for emphasis. The first membrane 21 includes a flap portion or peninsula 41 defined by at least one scored segment 42 and leaving a continuous portion 43 to serve as a hinge for the flap 41. The scored segment may be defined by an appropriate means such as mechanized cutting or laser ablation. The scored portions of the at least one scored segment 42 may or may not penetrate through the entire thickness of the first membrane 21. Until such time as the user causes the flap 41 to be freed from the first membrane 21, the flap portion 41 is preferably substantially restrained by the first membrane 21. An outer, substantially annular portion 44 of the first membrane 21 is disposed outside the periphery of the at least one scored segment 42 and substantially surrounds the flap portion 41.

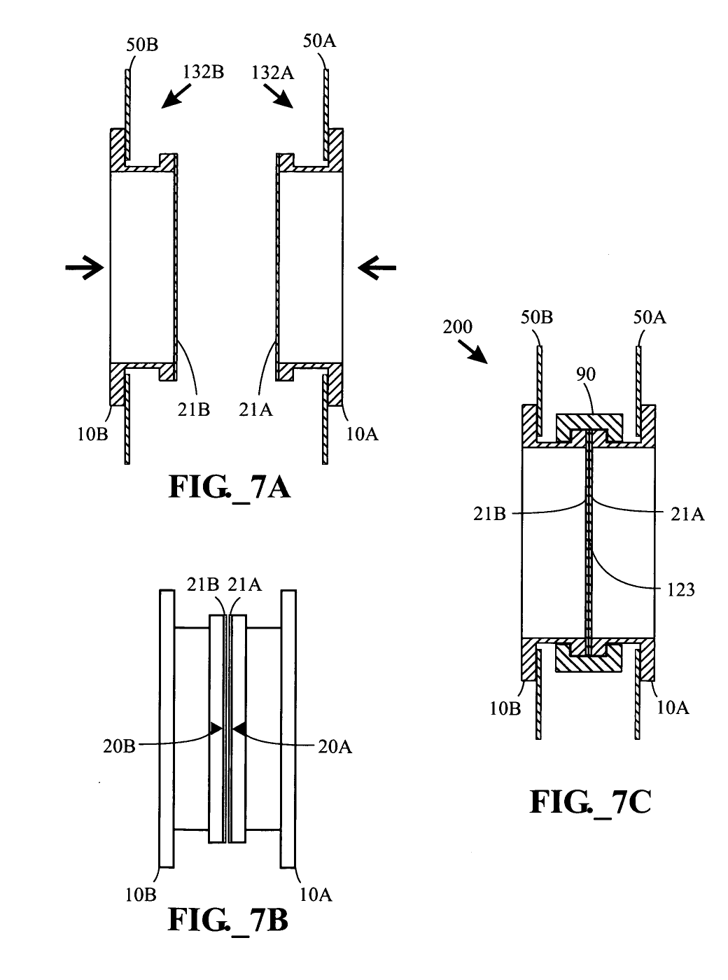

FIG. 7A illustrates a cross-sectional assembly view of two assemblies 132A, 132B each including a receptacle 50A, 50 and a flange 10A, 10B covered by a single flap-defining membrane 21A, 21B. Horizontal arrows indicate the direction in which the assemblies 132A, 132B may be moved to permit them to be joined together. As noted previously, the outer surface 23 of each flap-defining first or inner membrane 21A, 21B preferably comprises an adhesive, such that the inner membranes 21A-21B may be adhered to one another upon contact. As shown in FIG. 7B, which illustrates a side view of the two flanges 10A, 10B and first membranes 21A, 21B, the flanges 10A, 10B are preferably aligned or registered to one another with the aid of alignment marks 20A, 20B to ensure that the flap portions 41 of the first membranes 21A, 21B are registered to one another.

After the two flanges 10A, 10B are registered to one another, the flanges 10A, 10B are pressed against one another to make adhesive contact between the first membranes 21 A, 21B. An assembly 200 showing the interconnection of two receptacles 50, 50 having flanges 10A, 10B and first membranes 21A, 21B is shown in FIG. 7C. Maintenance of contact between the first membranes 21A, 21B along an interface 124, and further structural support for the joined flanges 10A, 10B is provided by a circumferential clamp 90 joined around the flanges 51A, 51B, preferably around the outer lip 16 of each flange. As noted previously, until the flap portion 41 of each membrane 21A, 21B is freed from its surrounding annular portion 44, the flap portion 41 remains substantially restrained by the annular outer membrane portion 44.

As may be gathered by reviewing the foregoing disclosure, a method for facilitating substance transfer between two receptacles includes several method steps. A first step includes providing a first receptacle having a first protruding flange including a first wall defining a first aperture and having a first inner membrane joined to the first flange, with the first inner membrane spanning across the first aperture and defining a first flap portion substantially restrained by the first inner membrane. A second step includes providing a second receptacle having a second protruding flange including a second wall defining a second aperture and having a second inner membrane joined to the second flange, with the second inner membrane spanning across the second aperture and defining a second flap portion substantially restrained by the second inner membrane. A third method step includes registering the first flange and the second flange such that the first flap portion is substantially registered with the second flap portion. A fourth method step includes joining the first flange and the second flange, preferably including adhering the first outer surface to the second outer surface. A fifth method step includes freeing the first flap portion from the first inner membrane and the second flap portion from the second inner membrane to open a pathway between the first receptacle to the second receptacle, preferably by separating each flap portion along a predefined scored segment from its surrounding membrane. Preferably, each receptacle initially has an outer membrane that is removed prior to expose the inner membrane prior to the joining step. Once the pathway is open between the receptacles, at least a portion of any of a first substance initially contained in the first receptacle and a second substance (if any) initially contained in the second receptacle may be transferred to the other receptacle.

Another embodiment is directed to a method for forming a substance transfer pathway between two or more volumes without exposing the interior contents of said two or more volumes to an environment exterior to said volumes. Each volume has an outlet and is bounded by an interior surface including an interior surface of an outlet cover, with the outlet cover having an exterior surface. The method includes the steps of:
(a) registering the exterior surface of the outlet cover of a first volume with the exterior surface of the outlet cover of a second volume;
(b) sealing the exterior surface of the outlet cover of the first volume to the exterior surface of the outlet cover of the second volume; and
(c) opening a pathway through the outlet of the first volume and the outlet of the second volume without exposing the interior contents of the first volume and the second volume to any of the exterior surface of the first outlet cover and the second outlet cover.
   The two or more volumes may include any of receptacle(s) and conduit(s), with exemplary conduits being any of any of a tube, a hose, a pipe, and a duct.

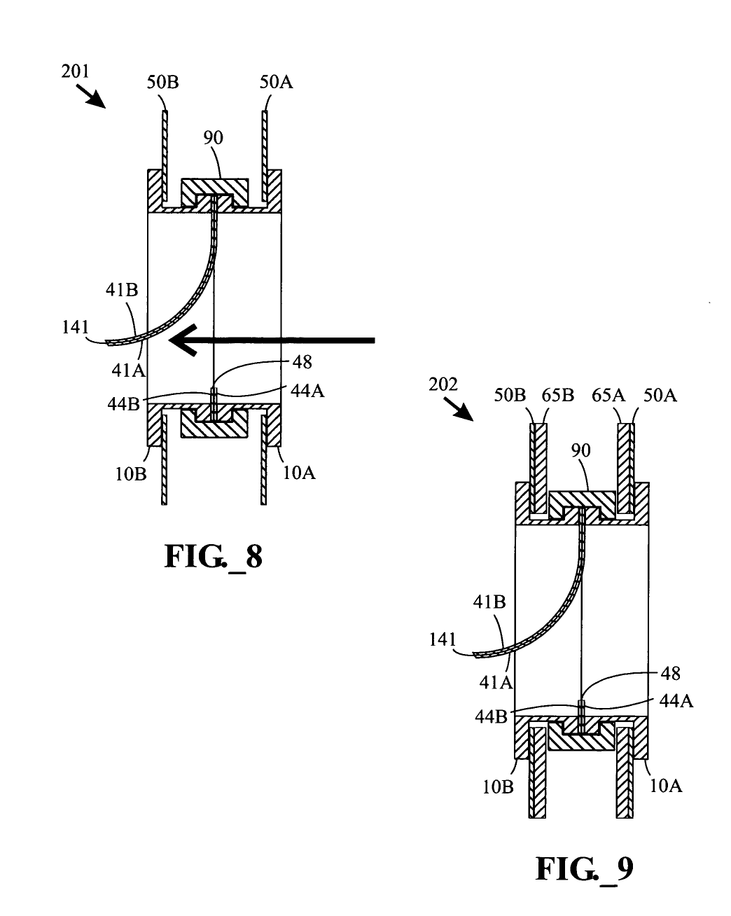

FIG. 8 illustrates, in cross-sectional view, an assembly 201 substantially identical to the previous assembly 200, but showing (or following) the freeing of the flap portions 41A, 41B from the membranes 21A, 21B (shown in FIG. 7C), with the flap portions being adhered together along an interface 123 (shown in FIG. 7C) to form a composite flap 141. Contact pressure may be used to free the flap portions 41A, 41B from the membranes 21A, 21B. Assuming the use of a substantially non-rigid receptacles 50A, 50B, such as may be formed from polymeric films, the flap portions 41A, 41B may be freed from the membranes 21A, 21B by pressing a finger or rigid instrument against the outer surface 55 of one receptacle wall 51 opposite the corresponding flange 10A, 10B, thus partially collapsing the receptacle wall 51 to contact the flap portions 41A, 41B, with further pressure being applied (e.g., in the direction of the large arrow illustrated in FIG. 8) to separate or free the composite flap 141 from the surrounding annular portions 44 of the adhered membranes 21A, 21B along the at least one scored segment 42. The composite flap 141 remains connected to the adhered membranes 21A, 21B by way of the continuous portion or hinge 43 associated with each membrane 21A, 21B. In this manner, the composite flap 141 can swing freely and an aperture or pathway 48 is opened between the two receptacles 50A, 50B to permit substances to be transferred therebetween.

In another embodiment, receptacle or conduit having an associated connector further includes an associated poking element or lever element adapted to permit the user to open a passage between two volumes. Such a poking or lever element may be attached to any of a receptacle wall, conduit wall, flange, or membrane/boundary element. In one embodiment, at least a portion of a lever tool or poking tool is mated or otherwise disposed between an inner membrane/boundary element and an outer membrane/cover element, such that upon the establishment of a connection between two volumes as provided herein, at least a portion of the lever or poking element is sandwiched between two adhered between the exterior surfaces of two inner membranes or boundary elements. The poking or lever element may be operated by the user to free a composite flap and thus open a substance transfer path between two or more volumes. In one embodiment, a portion of the lever of poking element is external to the volumes and connectors to permit the external manipulation by a user. In another embodiment, such a lever or poking element is fully contained within the volumes and/or connectors, with manipulation of the same being possible through a flexible wall of a connector or by other appropriate non-contact means such as magnetic actuation if a magnetic or magnetizable element is provided with the poking or lever element.

FIG. 9 illustrates, in cross-sectional view, an assembly 202 substantially identical to the previous assembly 201, but with the addition of an external support or tank 65A, 65B associated with each receptacle 50A, 50B (and with the omission of the directional arrow illustrated in FIG. 8). In this manner, each receptacle 50A, 50B can serve as a disposable liner within its respective support or tank 65A, 65B. The use of external supports or tanks can provide secondary containment for the contents of a liner-type receptacle, means for manipulating (e.g., shaking or rotating) otherwise unwieldy liner-type receptacles, and/or permit the use of substantially thinner liners than could otherwise be used for a given application.

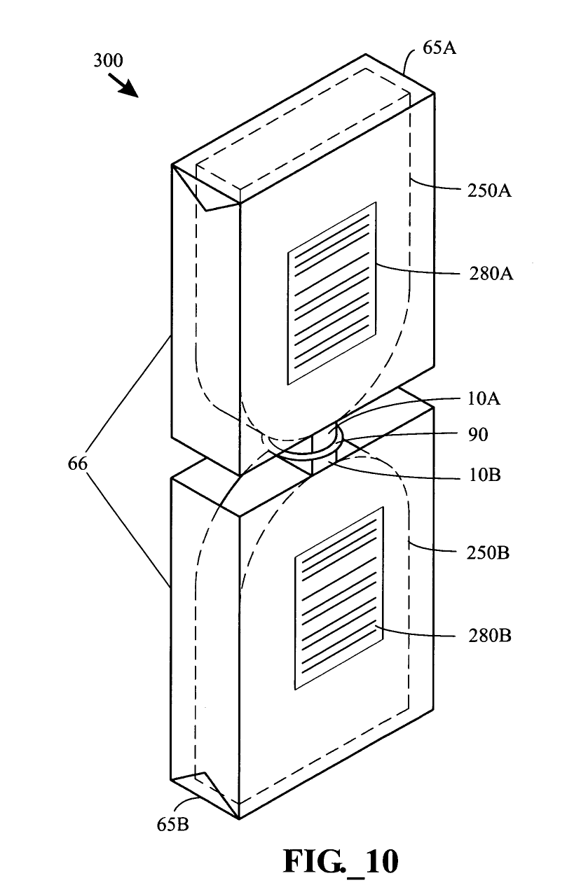

FIG. 10 illustrates a processing assembly 300 according to one embodiment including two flexible receptacles 250A, 250B joined with connector flanges 10A, 10B according to the present invention mated with a clamp 90, the receptacles 250A, 250B being contained within substantially rigid external tanks or supports 65A, 65B. The supports 65A, 65B may be separately fastened to one another to form a support subassembly 66, such as may be joined to any of various mechanisms to promote manipulation of the joined receptacles 250A, 250B. FIG. 10 further depicts instructions or indicia 280A, 280B printed, adhered, or otherwise located on or in any of the receptacles 250A, 250B and the supports 65A, 65B. Such instructions or indicia may provide direction to a user in performing method steps, such as for joining the receptacles, indicating or processing substances therein, and/or handling or disposing of substances or the receptacles. In another embodiment, instructions or indicia may be located on packaging material associated with the receptacles 250A, 250B, or disposed on the second (outer) membrane associated with a receptacle connector. Various combinations of one or more receptacles, packaging, and instructions or indicia may be bundled into kits.

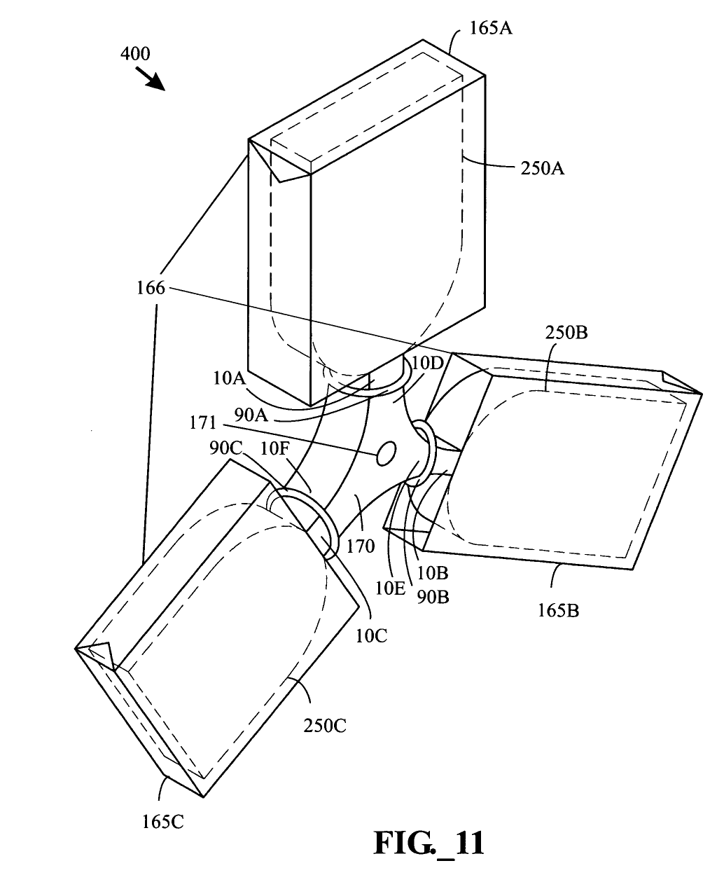

FIG. 11 illustrates another processing assembly 400 similar to the assembly 300 illustrated in FIG. 10, but with certain distinctions. The assembly 400 includes three receptacles 250A-250C rather than two, and rather than being directly coupled to one another, the receptacles 250A-250C are coupled via an intermediate conduit 170 by way of multiple connectors 10A-10F. The conduit 170 includes internal passages permitting substance transfer between the receptacles 250A-250C. Opposing connector pairs 10A, 10D; 10B, 10E; and 10C, 10F each include mating flap portions that permit contamination-free coupling between the receptacles 250A, 250B, 250C and the conduit 170. Clamps 90A-90C may be provided for further support in joining the receptacles 250A-250C to the conduit 170. The conduit 170 may further include a functional element 171 to provide any of: further interconnection capability, viewing or monitoring capability, or mounting capability (e.g., for mounting the assembly 400 to an external mechanism to accomplish any suitable substance processing step). Each receptacle 250A-250C is contained within a substantially rigid external tank or support 165A-165C. The supports 165A-165C may be separately fastened to one another to form a support subassembly 166, such as may be joined to any of various mechanisms to promote manipulation of the joined receptacles 250A-250C.

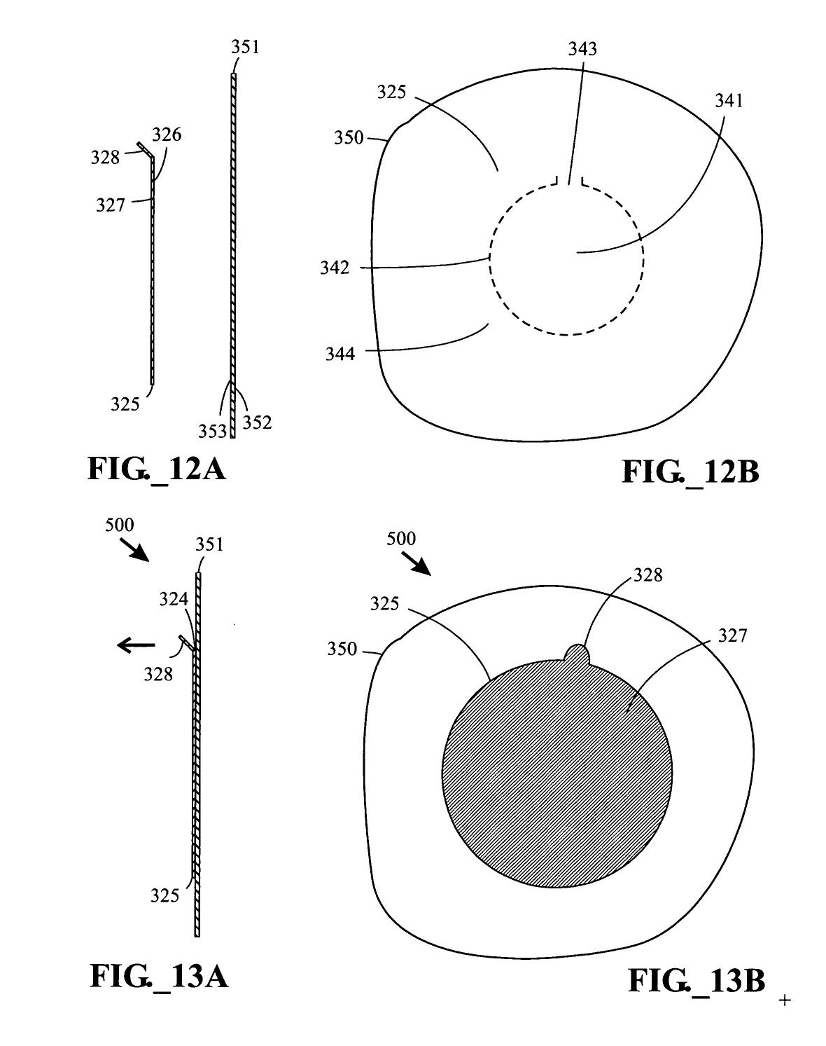

Another embodiment is directed to flangeless connectors providing similar utility to the flanged connectors described previously. A flap-defining portion of a boundary element 351 (e.g., the wall of a receptacle or conduit 350) and an associate cover element 325 are illustrated in FIGS. 12A-12B. Such an embodiment preferably utilizes a boundary element 351 (having interior and exterior surfaces 352, 353, respectively) fabricated from a substantially nonrigid material such as a polymeric film. A flap portion 341 preferably including at least one scored segment 142 is defined directly in the boundary element 351 leaving a continuous portion 143 to serve as a hinge for the flap 141. An outer, substantially annular portion 344 of the boundary element 351 may be coated with an adhesive to facilitated joining of the receptacle or conduit 350 to another receptacle or conduit of like type. In a preferred embodiment, such adhesive is activated or cured by external means (e.g., heat or radiation) after two receptacles and/or conduits are placed into contact with one another. Thus, the cover 325 may be removed to expose adjacent flap portions prior to the contact step, but after activation or curing the joined receptacles and/or conduits resist separation. The cover 325 includes interior and exterior surfaces 326, 327, respectively.

An assembly 500 including the flap-defining receptacle or conduit 350 and the cover 328 is illustrated in FIGS. 13A-13B. An arrow illustrated in FIG. 13A indicates the direction in which the cover 325 may be removed from the outer surface 353 by a user via the peripherally extended portion or pull tab 328. The joint 324 between the cover 325 and the boundary element 351 preferably includes a nonpermanent adhesive. The cover 328, which is shaded for emphasis in FIG. 13B, is intended to be removed from the receptacle or conduit 350 prior to a step of joining the receptacle or conduit 350 to another of like type. Following removal of respective covers 325, the flap portions 341 of two receptacles and/or conduits 350 are registered with one another, and the flap portions are placed into contact with one another to provide contact adhesion. Further adhesive is preferable provided in the annular portion 344 of the boundary elements 351 around the flap portions 341 to promote sealing between the two receptacles and/or conduits 350.

To promote good contact adhesion between adjacent restrained flap portions without bubbles or undesirable effects during a joining step, one or both adjacent receptacles and/or conduits may be pressurized to cause one flap portion to bulge or curve outward toward the other.

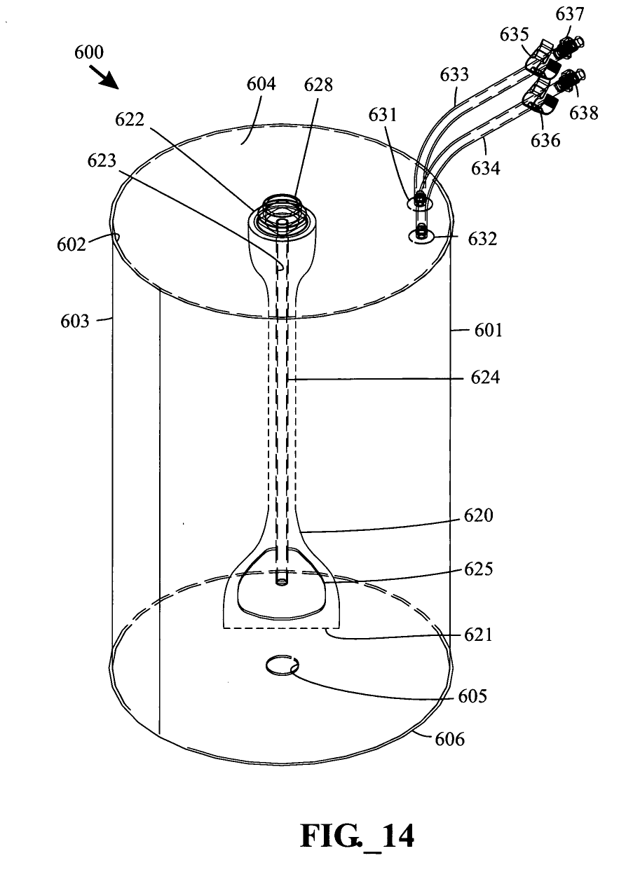

An assembly 600 including a processing receptacle 601 for use with a connector as described herein is illustrated in FIG. 14. The receptacle 601 includes a cavity-defining sealed sleeve 620 joined to (e.g., the top 604 of) the receptacle 601 and protruding into the receptacle 601. The cavity 623 contains a mixing paddle 625 and support rod 624. The function of the sleeve 620 is to serve as an isolation barrier between the mixing elements 624, 625 and the interior of the receptacle 601. If desired, the sleeve 620 may be fabricated from a polymer film with a lower seam 621 provided after the mixing elements 624, 625 are inserted into the sleeve 620, such that any of the mixing elements 624, 625 may be permanently retained by the sleeve 620. The sleeve 620 and mixing elements 624, 625 may be used to free a flap associated with a connector flange, such as a flap 41 associated with the flange 10 described previously. The sleeve 620 may include a reinforced aperture-defining coupling guide 628 to permit the support rod 625 to be inserted into the sleeve 620 and/or permit an external mixing mechanism (not shown) to be coupled to the support rod 625 while resisting puncture or damage of the sleeve 620. In operation, the paddle 625 and rod 624 contained within the sleeve 625 are preferably directed in a circular, oval, or other appropriate path within the receptacle 601 to stir or mix substances contained therein.

An upper seam 622 preferably joins the sleeve 620 to the upper wall 604 of the receptacle 601, with the sleeve 620 preferably permanently joined to the receptacle 601. Both the receptacle 601 and sleeve 620 preferably comprise polymeric materials suitable for economical single use (i.e., disposable) operation. In one embodiment, each of the receptacle 601 and sleeve 620 comprises a polymeric film; in a particularly preferred embodiment, each of the receptacle 601 and sleeve 620 comprises a substantially optically transmissive or transparent film. If desired, a substantially open external frame (not shown) may be provided to support the receptacle 601 with associated hooks or connectors (not shown). The upper wall of the receptacle further defines apertures 631, 632 serving as access ports for the admission of substances into the receptacle 601. Each aperture or port 631, 632 preferably has an associated supply line 633, 634, sealing element 635, 636, and coupling element 637, 638. The lower wall 606 of the receptacle 601 defines an aperture 605 adapted to receive a connector flange 10 such as provided herein. In this manner, the processing receptacle 601 may be joined to another receptacle (not shown), and substances exchanged therebetween may be processed.

Receptacles including connector flanges as provided herein may be put to various desirable uses. In one embodiment, such receptacles may be used to mix and/or react industrial chemicals. In another embodiment, receptacles may be used to assist in pharmaceutical development, formulation, or manufacture, such as by processing at least one material selected from: drug precursor materials, therapeutic agents, binding materials, bulk materials, coloring agents, flavoring agents, stabilizing agents, preservatives, and reagents is added to a processing receptacle. In another embodiment, receptacles as described herein may be used to process (e.g., mix, react, and/or ferment) biological materials. In still another embodiment, receptacles as described herein may be used to process semiconductor precursor and/or processing materials, such as by combining wet solutions with abrasive materials to yield chemical mechanical polishing or planarization (CMP) slurries.

Various combinations of elements disclosed herein may be made to provide additional advantage. For example, volumes including receptacles and/or conduits may have one or more associated connectors. In another example, assemblies including of receptacles and/or conduits including connectors as disclosed herein may be provided. In another example, substance processing systems may include interconnected receptacles and/or conduits as provided herein, possibly combined with additional mixing elements. In yet another example, kits including various combinations of receptacles with connectors, conduits with connectors, substances contained or disposed therein, packaging, and/or instructions or indicia may be provided.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A connector for any of a receptacle and a conduit, the connector comprising:
a flap defined in a boundary element bounding at least a portion of an interior volume defined by a first receptacle or conduit, wherein a portion of the flap is adapted to be separated from the boundary element; and
a cover removably joined to the boundary element and spanning across the flap.

2. The connector of claim 1, wherein the boundary element comprises an exterior wall of the first receptacle or conduit.

3. The connector of claim 1, further comprising a protruding flange disposed between the boundary element and the first receptacle or conduit, wherein the flap is joined to the flange.

4. The connector of claim 1, wherein the flap has an exterior surface, and the exterior surface comprises an adhesive material.

5. The connector of claim 1, wherein the flap is substantially restrained by the boundary element.

6. The connector of claim 1, wherein the boundary element comprises any of a collapsible material and a substantially non-rigid material.

7. The connector of claim 1, wherein any of the boundary element and the cover comprises a polymeric film.

8. The connector of claim 1, wherein the cover comprises a pull tab.

9. The connector of claim 1, further comprising an externally visible alignment mark.

10. The connector of claim 1, further comprising instructions or indicia disposed in or on any of the boundary element and the cover.

11. A receptacle having a connector according to claim 1, wherein each of the receptacle and the connector has an interior surface, and each interior surface has a surface concentration of 1 micron or greater size particulates of less than about 1 particle per square centimeter.

12. The receptacle of claim 11, wherein the interior surface of each of the receptacle and the connector is substantially sterile.

13. A receptacle having a connector according to claim 1, wherein each of the receptacle and the connector comprises a polymeric material containing no more than about 0.05 weight percent of any porogen.

14. A conduit comprising a first end having a first connector according to claim 1 and a second end having a second connector according to claim 1.

15. An assembly comprising a first receptacle having a first connector according to claim 1 and any of: (A) a second receptacle having a second connector according to claim 1, and (B) a conduit having a third connector according to claim 1.

16. A substance processing system comprising the receptacle of claim 11.

17. The substance processing system comprising:
a receptacle having a connector according to claim 1l; and
a mixing element adapted to mix any contents of the receptacle.

18. A connector for any of a receptacle and conduit, the connector comprising:
a protruding flange including a wall defining an aperture;
a first membrane joined to the flange and spanning across the aperture, the first membrane having an inner surface, having an outer surface, and defining a flap portion; and
a second membrane removably adhered to the outer surface of the first membrane.

19. The connector of claim 18, wherein the second membrane is removably adhered to the first membrane with an adhesive.

20. The connector of claim 19, wherein the adhesive comprises an anti-microbial substance.

21. The connector of claim 18, wherein the flap portion is substantially restrained by the first membrane and is bounded by at least one scored segment defined in the first membrane.

22. The connector of claim 21, wherein the at least one scored segment is defined by laser ablation.

23. The connector of claim 18, wherein any of the first membrane and the second membrane comprises a polymeric film.

24. The connector of claim 18, wherein at least a portion of the second membrane extends radially outward past the wall.

25. The connector of claim 18, wherein the at least a portion of the second membrane extending radially outward past the wall comprises a pull tab.

26. A receptacle comprising the connector of claim 18.

27. The receptacle of claim 26, wherein the receptacle comprises any of a collapsible material and a substantially nonrigid material.

28. The receptacle of claim 26, further comprising instructions or indicia disposed on the second membrane.

29. The receptacle of claim 26, wherein the receptacle comprises a polymeric film.

30. A substance processing system comprising the receptacle of claim 26.

31. The substance processing system of claim 30, further comprising a mixing element adapted to mix the contents of the receptacle.

32. A kit comprising:
a first receptacle having a first connector according to claim 18 and containing a first substance; and
a second receptacle having a second connector according to claim 18 and containing a second substance.

33. A kit comprising the receptacle of claim 26 and instructions or indicia for any of the use of the receptacle and interconnection of the receptacle with another receptacle or conduit.

34. A kit comprising:
a first receptacle having a first connector according to claim 18;
a second receptacle having a second connector according to claim 18; and
instructions or indicia disposed on, disposed in, or packaged with any of the first receptacle and the second receptacle.

35. The kit of claim 34, further comprising a clamp adapted to join the first receptacle to the second receptacle.

36. The kit of claim 34, wherein each of the first connector and the second connector includes an alignment mark.

37. An assembly comprising a first receptacle according to claim 26 and a second receptacle according to claim 26 joined with a clamp.

38. A method for facilitating substance transfer between two receptacles, the method comprising the steps of:
providing a first receptacle having a first protruding flange including a first wall defining a first aperture and having a first inner membrane joined to the first protruding flange, wherein the first inner membrane has a first inner surface and a first outer surface, spans across the first aperture, and defines a first flap portion substantially restrained by the first inner membrane;
providing a second receptacle having a second protruding flange including a second wall defining a second aperture and having a second inner membrane joined to the second protruding flange, wherein the second inner membrane has a second inner surface and a second outer surface, spans across the second aperture, and defines a second flap portion substantially restrained by the second inner membrane;
registering the first flange and the second flange such that the first flap portion is substantially registered with the second flap portion;
joining the first flange and the second flange;
freeing the first flap portion from the first inner membrane and the second flap portion from the second inner membrane to open a pathway between the first receptacle to the second receptacle.

39. The method of claim 38, wherein the first receptacle initially has a first outer membrane proximate to the first inner membrane and the second receptacle initially has a second outer membrane proximate to the second inner membrane, the method further comprising the step removing the first outer membrane and the second outer membrane to expose the outer surface of the first inner membrane and the outer surface of the second inner membrane prior to the joining step.

40. The method of claim 38, wherein the joining step includes adhering the first outer surface to the second outer surface to join the first flap portion to the second flap portion.

41. The method of claim 38, wherein the first receptacle contains a first substance, the method further comprising the step of transferring at least a portion of the first substance from the first receptacle to the second receptacle through the pathway.

42. The method of claim 38, wherein the first flap portion comprises a portion of the first membrane bounded by at least one first scored segment and the second flap portion comprises a portion of the second membrane bounded by at least one second scored segment, and the freeing step includes separating the first membrane along the at least one first scored segment and separating the second membrane along the at least one second scored segment.

43. A method for forming a substance transfer pathway between two or more volumes without exposing the interior contents of said two or more volumes to an environment exterior to said volumes, wherein each volume has an outlet and is bounded by an interior surface including an interior surface of an outlet cover, said outlet cover having an exterior surface, wherein said method comprises the steps of:
registering the exterior surface of the outlet cover of a first volume with the exterior surface of the outlet cover of a second volume;
sealing the exterior surface of the outlet cover of the first volume to the exterior surface of the outlet cover of the second volume; and
opening a pathway through the outlet of the first volume and the outlet of the second volume without exposing the interior contents of the first volume and the second volume to any of the exterior surface of the first outlet cover and the second outlet cover.

44. The method of claim 43, wherein the two or more volumes comprise at least two receptacles.

45. The method of claim 43, wherein any receptacle of the at least two receptacles comprises any of a collapsible material and a substantially nonrigid material.

46. The method of claim 43, wherein any receptacle of the at least two receptacles comprises a polymeric film.

47. The method of claim 43, wherein the two or more volumes comprise a receptacle and a conduit.

48. The method of claim 47, wherein the conduit comprises any of a tube, a hose, a pipe, and a duct.

49. The method of claim 45, wherein the exterior surface of the outlet cover of any of the first volume and the second volume comprises an adhesive to seal upon contact the exterior surface of the outlet cover of the first volume to exterior surface of the outlet cover of the second volume.

50. The method of claim 43, wherein the outlet cover of the first volume comprises a first alignment mark, the outlet cover of the second volume comprises a second alignment mark, and the registering step includes aligning the first alignment mark and the second alignment mark.

51. The method of claim 43, wherein the outlet of the first volume includes a first flange, and the outlet of the second volume includes a second flange, the method further comprising the step of joining the first flange to the second flange.

52. The method of claim 43, wherein the joining step includes clamping the first flange to the second flange.

53. An assembly of two or more interconnected volumes having a substance transfer pathway formed according to the method of claim 43.
